(19) United States
(12) Patent Application Publication
(10) Pub. No.: US 2013/0243541 A1
(43) Pub. Date: Sep. 19, 2013

(54) COMBINED THERMAL FIT AND ROTATIONAL LOCKING MACHINE TOOL ASSEMBLY

(71) Applicant: TECHNIKS, INC., Indianapolis, IN (US)

(72) Inventors: John A. Stagge, Indianapolis, IN (US); Michael S. Eneix, Indianapolis, IN (US)

(21) Appl. No.: 13/831,457

(22) Filed: Mar. 14, 2013

Related U.S. Application Data
(60) Provisional application No. 61/610,724, filed on Mar. 14, 2012.

(51) Int. Cl. B23Q 3/12; B23B 31/00; B23C 5/26

(52) U.S. Cl. CPC B23Q 3/12; B23C 5/26; B23B 31/005
USPC 409/234; 279/96

(57) ABSTRACT

An illustrative embodiment of a machine tool assembly has a tool holder, a keyed recess, and a cutting tool. The assembly prevents relative rotation and substantially reduces eccentricity between a cutting tool and a tool holder. The tool holder has a receiving bore axially formed at the tool end of the tool holder. The keyed recess is at the base of the receiving bore. The keyed recess has multiple corners formed around an inner surface of the recess. The cutting tool has a cylindrical shank and multiple edges formed on the machine tool end of the shank. The cylindrical receiving bore has diameter that is less than the diameter of the tool shank so that a thermal transitional fit is provided. Coupling of the cutting tool and holder includes heating the holder until the diameter of the bore expands sufficiently to receive the tool shank. When inserted within the bore of the holder and into the keyed recess, the multiple edges of the cutting tool abut with the multiple corners of the recess.

### CROSS-REFERENCE TO RELATED APPLICATIONS

This is a nonprovisional patent application of U.S. Provisional Patent Application No. 61/610,724, filed Mar. 14, 2012, and titled COMBINED THERMAL INTERFERENCE FIT AND ROTATIONAL LOCKING MACHINE TOOL ASSEMBLY, which is incorporated herein by reference.

### BACKGROUND

The present invention relates to a machine tool holders and cutting tools, and more particularly to a machine tool assembly for a machine tool spindle.

Cutting tools and holding systems for milling machines, machining centers, and other machine tools typically have a clearance fit that allows easy assembly and disassembly of the cutting tool and holder, and a mechanism that provides secure clamping of the cutting tool relative to the tool holder.

For example, a first machine tool holding system, for example, as shown in FIG. 6, shows a tool holder having a through hole formed axially through the tool holder and threaded holes and associated set screws oriented radially through the tool holder. The cutting tool includes flats formed on one side of its shank. The shank is inserted into the through hole of the tool holder and the set screws are tightened, engaging them against the flats of the tool shank. Accordingly, the engagement of the set screws and shank flats secure the holder and tool axially and rotationally, and the conventional machine tool assembly is ready for operation.

However, the engagement of the set screws with the shank flats presses the cutting tool against the side wall of the axial through hole, opposite the set screws. Thus, securing the tool shank relative to the tool holder forces the cutting tool to be eccentric to the tool holder and thus to the tool rotation.

This eccentricity is often referred to as Total Indictor Reading or TIR. TIR is the enemy of tool service life. Even a very small reduction of TIR can increase tool life substantially. Excessive heating and/or vibration caused by TIR can drastically reduce the usable lifespan of a cutting tool. With excess TIR and the shank and through hole of the tool holder and cutting tool not in firm contact around their full circumference and length, excessive vibration and subsequent excessive heating can develop. For example, as the cutting tool contacts the material being machined, eccentricity and the clearance gap in fit between the cutting tool and tool holder result in vibration that transforms what should be a continuous shaving of material from the work piece into non-continuous, rapid bites that overheat and prematurely wear the cutting tool. If the cutting surface is a carbide insert, or the whole cutting tool is carbide, the vibration and premature wear is even greater due to the brittleness of carbide compared to conventional tool steel.

Excess TIR and premature cutting tool wear can increase the scrap rate of potentially expensive parts, especially when an out of tolerance finish cut results. Excess TIR also causes uneven wear between blades or inserts of the cutting tool, necessitating replacement before all have worn out.

To maximize the service life of the cutting tool and reduce the scrap rate of parts being machined, it is desirable to reduce the eccentricity and improve the fit of the cutting tool and tool holder interface and thus reduce TIR, vibration, and heating.

A second machine tool holding system, for example, as shown in U.S. Pat. No. 4,955,764, includes a tool holder, a cutting tool, a spring collet, and a collet nut. The tool holder generally includes a through hole axially formed through the tool holder, both for receiving the spring collet and the cutting tool on the distal chuck end (tool end), and for supplying coolant from the machine tool spindle to the work piece, either through or around the cutting.

The distal end of the through hole in the tool holder includes a tapered recess or chuck that is shaped to receive and compress the spring collet. The spring collet includes a through bore that receives the shank of the cutting tool. Tightening of the collet nut onto the distal end of the tool holder axially drives the spring collet deeper into the tapered recess, compressing the spring collet radially, and thus clamping shank of the cutting tool within the interior bore of the spring collet, axially centering and fixing the cutting tool within the tool holder, thus eliminating any eccentricity and TIR such as that discussed above for the first conventional tool holder system.

Although the collet nut and associated tapers of the collet and collet chuck portion of the tool holder do compress and clamp cutting tool centered within the spring collet, the strength with which the spring collet clamps the cutting tool is sometimes insufficient, especially with the higher machining forces, especially torque, transmitted with the materials, feed rates, and RPM that can be withstood by modern cutting tools or inserts, for example, carbide inserts on indexable cutting tools. The cross sectional shapes of the cutting tool and the through hole of the tool holder are round, so a relative rotation (twist) between the tool holder and the cutting tool may still occur during use. For example, the relatively small diameter of the shank of the cutting tool that is held by the interior bore of the collet may, under sufficient operating torque, result in the cutting tool shank rotating within the collet. Such rotation can also cause axial pullout of the cutting tool from the tool holder because of the twisting action.

Rotational slippage and axial pullout can cause damage to the cutting tool and/or work piece. To avoid rotational slippage and axial pullout, feed rates and RPM must be limited, which is often impractical.

A third machine tool holding system, for example, U.S. Pat. No. 5,311,654 and U.S. Pat. No. 6,339,868, include a tool holder, having a tool mounting or holding portion, and a cutting tool. The tool holder generally includes a through hole axially formed through the tool holder, both for receiving the cutting tool on the distal end (tool end), and for supplying coolant from the machine tool spindle to the work piece, either through or around the cutting.

The distal end of the tool holder comprises the tool mounting portion and is generally a cylindrical elongate member, optionally having a tapered exterior surface, through which the through hole forms a cylindrical receiving bore for the matching cylindrical shank of the tool holder. The relative diameter and the tolerances of the inner surface of the receiving bore (ID) and the outside surface of the tool shank (OD) are such that the ID of the receiving bore is smaller than the OD of the tool shank. This relationship provides a thermal interference fit. Thus, to couple the cutting tool to the tool holder, the tool mounting portion of the tool holder is heated, thereby expanding the diameter of the ID of the receiving bore so that the tool shank easily slides into the receiving bore, and as the tool holder cools, the tool shank is firmly clamped within the smaller diameter receiving bore.

This tool holding system radially centers and axially and radially fixes the cutting tool within the tool holder, thus substantially reducing or eliminating eccentricity and TIR such as that discussed above for the first conventional tool holder system; however, in order for the strength with which the receiving bore clamps the cutting tool to be sufficient to the cutting tool shank rotating within the tool holder, the interference fit must be strong enough (ID>>OD) that uncoupling the cutting tool from the tool holder is very difficult, if not impossible to do.

This is especially true for indexable cutting tools, which typically have a tool shank made of tool steel that is the same or very close to that used for the tool holder. The tool shank and tool holder, being constructed of the same or a very similar material, have very similar thermal properties.

More specifically, the desired force with which the tool shank is held in the receiving bore of the tool holder prevents extraction without first expanding the ID of the receiving bore by heating; however, if the tool holder is heated, the tight contact and similar thermal properties of the tool holder and the cutting tool shank also very quickly heats the tool shank, expanding its OD at a rate that prevents extraction of the shank from the bore, even when the ID of the receiving bore expands. Yet the use of such indexable cutting tools is increasing, and the desired interference fit when using modern, high feed rate, high RPM indexable cutting tools must being even stronger than earlier cutting tools, making separation of the cutting tools and tool holder even more difficult and often impossible. Providing an indexable cutting tool with a carbide or other metal shank having a substantially different thermal expansion properties than the tool holder is generally cost prohibitive.

A fourth machine tool holding system, for example, U.S. Pat. No. 7,527,459, discloses a cutting tool having a stepped shank that is matingly received with a lower end of a tool holder. The cutting tool stepped shank is separated into three sections, a conical, tapered wedging section, a drive section having a polygonal cross-section, and a cylindrical section having an interior thread. The tool holder has an interior bore that includes three stepped sections that matingly receive the stepped tool shank. The cutting tool shank is drawing into the tool holder bore using a threaded pull stud/draw bar, mating the various sections. The mating of the drive section with its respective mating section prevents rotational slippage. The conical mating sections radial center the cutting tool to the tool holder; however, a distinct problem with conical, tapered mating sections that are not long in length is that eccentricity, or axial misalignment or tilt as this reference calls it, can occur. The eccentricity of the conical sections not perfectly aligning upon mating causes TIR from the axis of the cutting tool being misaligned with the axis of the tool holder. The cylindrical section of the tool shank mating with its respective cylindrical bore is provided to minimize the tilt; however, without an extended constant diameter, elongate cylindrical mating surface between tool holder and tool shank, some axial misalignment may remain. Additionally, pull stud/draw bar type tool holders are not always desirable or even usable in all application, for example, when coolant fluid is delivered through the center of the tool holder and cutting tool. Furthermore, the complex stepped sections and surfaces required on both the cutting tool and the tool holder make the tool holding system very expensive to manufacture.

Therefore, an improved and economical machine tool holding assembly that prevents tool rotation in the holder under high torque conditions while providing elimination of eccentricity and allowing easy, reliable coupling and uncoupling of the tool holder and cutting tool is desired.

### SUMMARY

The present invention may comprise one or more of the features recited in the attached claims, and/or one or more of the following features and combinations thereof.

The main objective of the invention is to provide a machine tool holder assembly that prevents a relative rotation and substantially reduces or eliminates eccentricity between a cutting tool and a tool holder, while also providing for coupling and decoupling of the cutting tool and tool holder.

An illustrative embodiment of a machine tool assembly has a tool holder, a keyed recess, and a cutting tool. The tool holder has a hole axially formed through at least a portion of the length of the tool holder, and a receiving bore axially formed with the hole at a tool mounting portion of the tool holder. The keyed recess is located within the tool holder, for example, at the base of the receiving bore. The keyed recess can be formed integrally with the tool holder, or can be formed in an adaptor screwed or otherwise rotationally secured in the bore. The keyed recess has multiple corners formed around an inner surface of the recess.

The cutting tool can have a non-standard diameter shank and multiple edges formed on the machine tool end of the shank. Coupling of the cutting tool and holder includes heating the holder until the diameter of the bore expands sufficiently to receive the tool shank. Decoupling of the cutting tool and holder includes holding the tool holder, heating the holder to expand the diameter of the bore, and pulling the shank from the receiving bore in the tool holder.

When inserted within the bore of the holder and into the keyed recess, the multiple edges of the cutting tool abut with the multiple corners of the recess. Because the cross sectional shape of the recess is multilateral and has multiple corners which the multiple edges abut, the combination of the corners and the edges prevent relative rotation between the tool holder and the cutting tool. The fit between the centers the cutting tool within the tool holder and prevents axial movement of the cutting tool relative to the tool holder.

The process of decoupling the tool holder and cutting tool can optionally including heating the tool holder to expand the bore diameter and reduce or eliminate the force required to pull the shank from the bore; however, the rapid transfer of heat to the cutting shank counteracts some of the benefit of expanding the bore diameter; thus, selecting a thermal fit, for example, a transitional fit, that eliminates eccentricity and axial pullout while cutting, yet allows the cutting tool shank and tool holder to be consistently decoupled without damage to the tool or holder, is desirable.

Additional features of the disclosure will become apparent to those skilled in the art upon consideration of the following detailed description and drawings of the illustrative embodiments.

### BRIEF DESCRIPTION OF THE DRAWINGS

FIG. 1A is a perspective view in partial section of a first embodiment of a machine tool holding assembly in accordance with the present invention;

FIG. 1B is an enlarged cross sectional end view of a keyed end of a cutting tool and keyed recess of a tool holder of the first embodiment of FIG. 1A;

FIG. 2 is a cross sectional side view of the machine tool assembly in FIG. 1

FIG. 3 is a perspective view in partial section of a coupling step of the first embodiment of a machine tool holding assembly in accordance with the present invention;

FIG. 4 is an enlarged cross sectional end view of a keyed end of a cutting tool and a keyed recess of a tool holder of a second embodiment of the machine tool holder in accordance with the present invention;

FIG. 5A is a cross sectional side view of the machine tool assembly in FIG. 1A;

FIG. 5B is an end view of the machine tool assembly in FIG. 1A; and

FIG. 6 is a side perspective view of a first prior art machine tool holding assembly.

### DETAILED DESCRIPTION

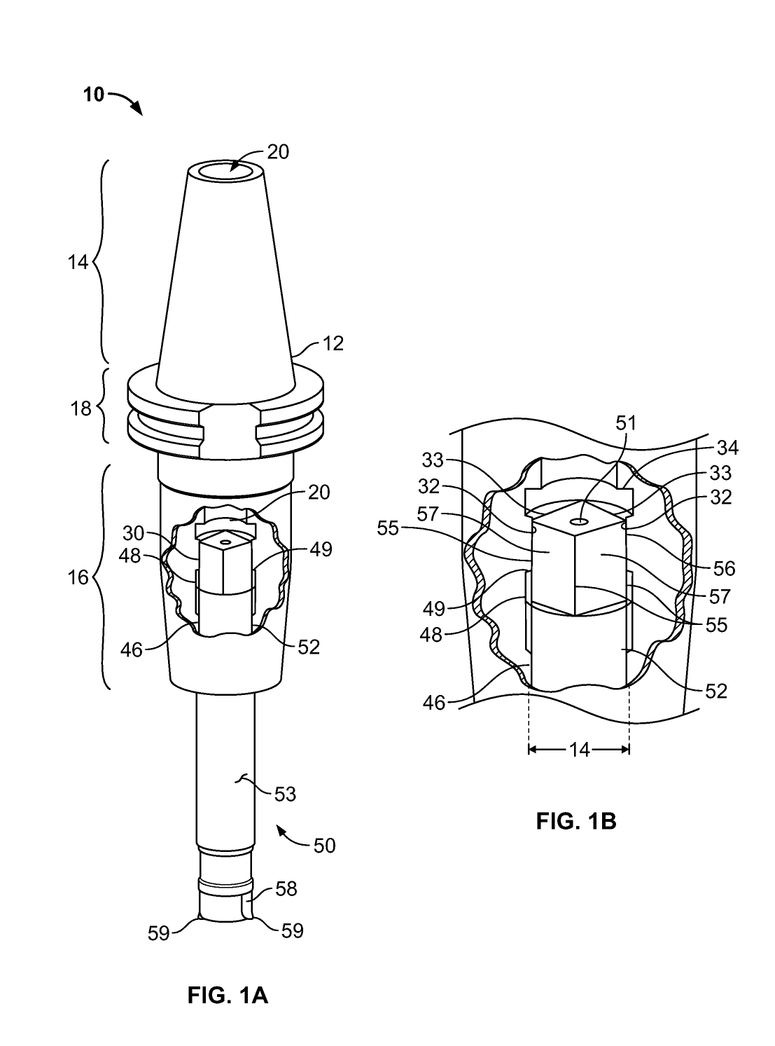

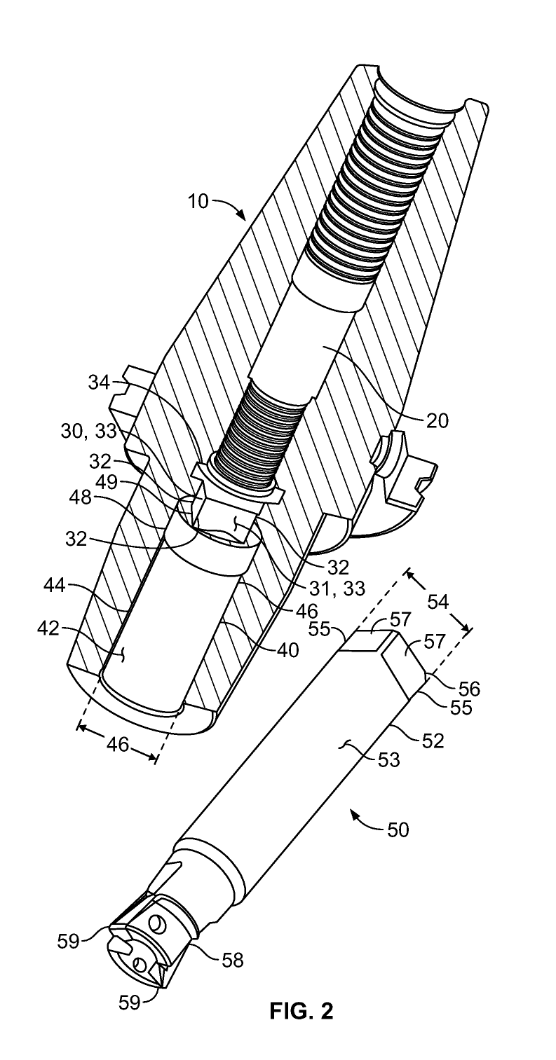

With reference to FIGS. 1 to 2, a first illustrative embodiment of a machine tool holder and assembly in accordance with the present invention comprises a tool holder 10 and a cutting tool 50.

The cylindrical tool holder 10 has a main body 12. The main body 12 has a connecting section 14, a tool mounting section 16, a flange section 18, and a through hole 20. The outer surface 22 of the connecting section 14 is tapered or semi-conical for engaging the machine spindle (not shown). The tool mounting section 16 is defined at a distal or the cutting tool end. The interior surface of the hole 20 in the tool mounting section 16 defines a keyed recess 30 and a receiving bore 40 for receiving a shank portion 52 of the cutting tool 50. The connecting section 14 of the main body 12 is defined at an opposite machine tool end from the tool mounting section 16. The flange section 18 is located between the connecting section 14 and the tool mounting section 16.

The hole 20 is optionally a through hole that defines not only the receiving bore 40, but also a coolant flow path from the machine spindle (not shown) to and/or past the cutting tool 50. For example, the cutting tool 50 can included a coolant hole 51, or the receiving bore 40 can have one or more slots 44 (FIG. 2) cut axial in the inner surface 42 of the bore through which coolant fluid can pass around the tool shank 52. In the illustrated embodiment, the through hole 20 is axially formed through the connecting section 14, the flange section 18, and the tool mounting section 16.

The receiving bore 40 in the illustrative embodiment includes a first segment 46 and a second segment 48. The first segment 46 has an inner diameter (ID) 47 dimensioned and toleranced sufficiently less than the dimension and tolerance of the outer diameter (OD) 53 of the shank 52 so that a fit ensuring axial alignment of the cutting tool 50 and tool holder 10 is provided. For example, a transitional fit for which thermal expansion of the receiving bore 40 provides for easy insertion and extraction of the tool shank 52. The second segment 48 is axially formed between the first segment 46 and the keyed recess 30 and has a diameter larger than ID 47 of the first segment 46, and is provided as a relief for the typical grinding process used to finish the first segment 46 of the bore 40 to the desired diameter and tolerance.

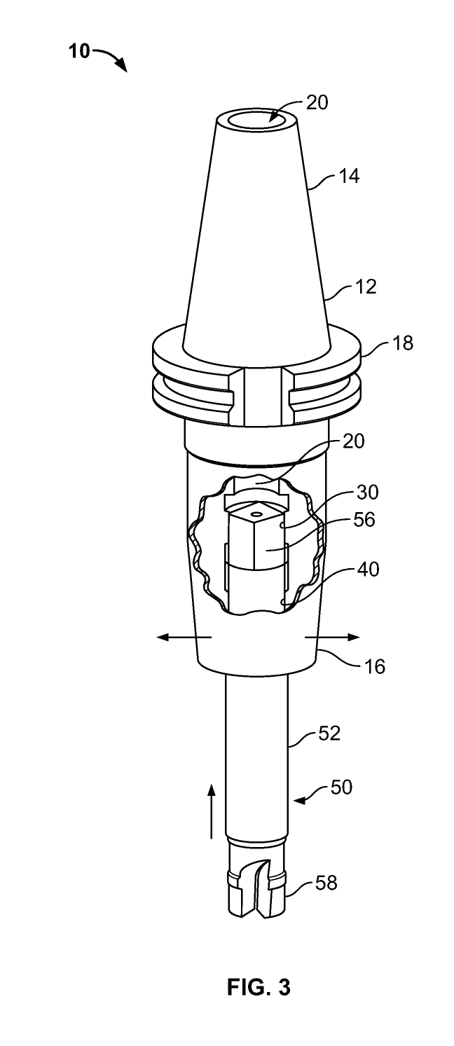

Referring to FIGS. 2 and 3, advantageously, the fit between the outer cylindrical surface 53 of the shank 52 defined by the cutting tool 50 and the inner cylindrical surface 42 of the receiving bore 40 defined by the tool holder 10 is a transitional fit that is closer to an interference fit than a clearance fit, for example, a fit for which thermal expansion of the receiving bore 40 provides for easy insertion and extraction of the tool shank 52. More specifically, the OD 54 of the tool shank 52 is dimensioned and toleranced to provide a thermal transitional fit providing little to no interference, and little to no clearance, for example, less interference than a typical industry standard dimensioned and tolerance ID 46 (FIG. 2) of the receiving bore 40, such as the tool receiving bore of Shrink Fit Tool Holders sold by Techniks, Inc., of Indianapolis, Ind. The desired fit does not provide clearance that allows insertion or extraction with mechanical forces or thermal expansion, including in the worst case of the specified tolerances, thus reducing TIR for the tool holder 10 upon coupling with the cutting tool 50, but also not so tight so that the cutting tool shank 52 can't be consistently extracted from the receiving bore 40. For example, it is desirable to provide a thermal transition fit that allows extraction by a hand (with gloves) upon heating the tool holder 10, for example, to about 300-800 degrees F., and more typically about 300-400 degrees F., depending on the diameter of the receiving bore 40 and tool shank 52. But without heating of the tool holder 10, the shank 52 is firmly held within the receiving bore 40 of the tool holder 10. For example, for a tool holder 50 formed from 4340, 4140, or H13 tool steel and a tool holder 10 formed from H13 or 8620 tool steel, an OD 54 of the tool shank 52 and an ID 31 of the associated bore 40 in the tool holder 10 sized and tolerance to provide the desired thermal transition fit according to the present invention can be as follows, in inches:

| | Tolerance |
|---|---|
| Shank OD | |
| 1.0000 | −0.0012/−0.0014 |
| 0.7500 | −0.0005/−0.0007 |
| 0.5000 | −0.0004/−0.0006 |
| Bore ID | |
| 1.0000 | −0.0012/−0.0015 |
| 0.7500 | −0.0008/−0.0010 |
| 0.5000 | −0.0006/−0.0008 |

Thus diameter of the OD 54 of the shank 52 is about equal too, or is slightly larger than the diameter ID 31 of the bore 40. In an alternative embodiment, the OD 54 of the shank 52 of the cutting tool 50 is a standard dimension and tolerance for cutting tools used in non-thermal interference holding systems, and the dimension and tolerance of ID 42 of the receiving bore 40 is determined to provide the desired thermal fit in accordance with the above embodiment.

Referring to FIG. 2, the recess 30 can be integral with the tool holder body 12, formed axially in hole 20 beginning at the base 49 of the second segment 48 of the receiving bore 40, and thus in communication with the bore 40. The inner surface 31 of the recess defines multiple corners 32 and/or multiple interleaving flats 33 at intervals around the interior circumference of the recess, and thus has a non-circular cross-section. The multiple corners 32 and flats 33 are axially aligned with the receiving bore 40. Referring to FIG. 2, further features of recess 30 can similarly be defined integrally by the tool holder body 12, including the multiple corners 32, associated flats 33, and the bottom 34. The recess 30 can be in open communication with the hole 20 formed in the connecting section 16 of the tool holder 10, or can be closed off.

With reference to FIGS. 2, the cutting tool 50 has a cutting end 58, a shank 52, and a keyed end 56, defined by a portion of the shank 52 opposite the cutting end. Cutting tools with related features to keyed end 56 sometimes refer to such features as the driving end or tang. When assembled with the tool holder 10, the cutting end 58 is located outside the tool mounting section 16 and the keyed end 56 and at least a portion of the shank 52, is located within the tool mounting section 16, specifically clamped in place by the receiving bore 40.

The keyed end 56 has an outer surface defining multiple edges 55 at intervals around its periphery. The recess 30 is sized and the multiple corners 32 of the recess are formed to receive the keyed end 56 such that the edges 55 abut the corners 32, thus preventing relative rotation of the cutting tool 50 about the machine tool body 12. Additionally or alternatively, surfaces 57 between the edges 55 of keyed end 56 and flats 33 between corners 32 of recess 30 are cooperatively adjacently positioned as shown in FIG. 1B to prevent relative rotation. Specifically, depending to the relative cross-sections and fit, the engagement of the keyed end 56 into the recess 30 may impede all relative rotation, for example, the cross-sections and dimensions of the keyed end 56 and recess 30 providing a slip fit, or the cross-sections and fit may allow only partial rotation before abutting of the edges 55 and corners 32 and/or associated flats 33 and 57 prevents further rotation. The flats 33 and 57 between edges 55 and corners 32 may be, but are not required to be planar surfaces, so long as the cooperation of features of the recess 30 and keyed end 56 prevent all relative or at least continuing rotation.

The keyed end 56 can have a cross-sectional shape the same as that of the recess 30, so the edges 55 respectively abut the corners 32. For example, the cross sectional shape of the keyed end 56 can be rectangular and provide four edges 32. Alternatively, the cross-sectional shape of the recess 30 may be different from that of the keyed end 56. For example, the cross-sectional shape of the recess 30 can be hexagonal and the cross sectional shape of the keyed end 56 can be triangular. The present invention does not limit the cross sectional shapes of the keyed end 56 and the recess 30 as a number of geometrically differing, but engage cross sections are known in the art that prevent continuing rotation of the cutting tool relative to the recess 30 and thus the machine tool body 12.

As shown in FIG. 3, the cutting tool 50 can have a coolant aperture 51 formed through the cutting tool 50 and communicating with the recess 30. Accordingly, coolant supplied by the machine spindle (not shown) can flow through the hole 20 and the cutting tool aperture 41 to cool the cutting tool 50 and a work piece. Additionally, the base 34 of the recess 34 or the base 49 of the second segment 48 can provide a stop surface to prevent axial translation of the cutting tool toward the connecting section 14 (machine spindle end), thus fixing the cutting tool axially relative to the machine tool holder body 12.

For either embodiment, in order to couple the tool holder 10 and cutting tool 50, the body 11 of the tool holder must be heated until the ID 46 of the receiving bore 40 surface 42 expands to a diameter at least equal to the OD 54 of the unheated cutting tool shank 52. The tool holder 10 and cutting tool 50 are then assembled as shown in FIG. 3 before the diameter 46 of the surface 42 of receiving bore 40 contracts from cooling.

Upon cooling, the fit of the receiving bore 40 and tool shank 52 ensure perfect alignment, removing eccentricity and TIR typical of prior machine tool holder assemblies, reducing uneven wear of cutting end 58 (including inserts 59, if applicable) and thus substantially improving the service life of the cutting tool 50 and reducing scrap parts rates because of the reduced vibration and heating achieved by eliminating the eccentricity from the coupling of the tool holder 10 and cutting tool 50. Additionally, the interface of the keyed end 56 and recess 30 prevents torsion applied to the cutting tool 50 in operation from rotating the cutting tool 50 relative to the tool holder 10. And advantageously, the reduction in the tightness of the fit between the bore 40 and tool shank 52, compared to that of the prior art thermal interference fit systems, achieved by using the engagement of the keyed end 56 into the recess 30 to prevent rotation, allows the cutting tool shank 52 to be removed or more easily removed from the receiving bore of the tool holder 10. To decouple the tool holder 10 from the cutting tool 50, the two must be pulled apart, for example, by heating the tool mounting section 16 of the tool holder 10 and pulling the cutting tool 50 axially so that the shank 52 is pulled out from the bore 40. Alternatively, at least for the first illustrative embodiment, the tool holder body 11 can be held and the tool shank 30 pressed distally from the receiving bore by applying mechanical pressure on the tool shank 52 through the hole 20.

The tool holder 10, including the shaft 38 can be made from typical tool steel, for example 8620. The cutting tool 50 also can be made from typical tool steel, for example H13. Both the tool holder 10 and the cutting tool 50 also can be heat treated according to processes typical for machine tools.

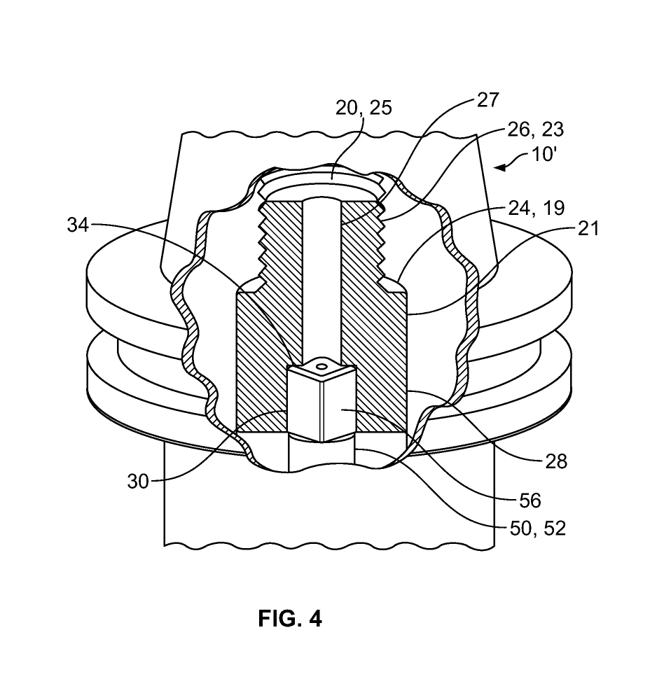

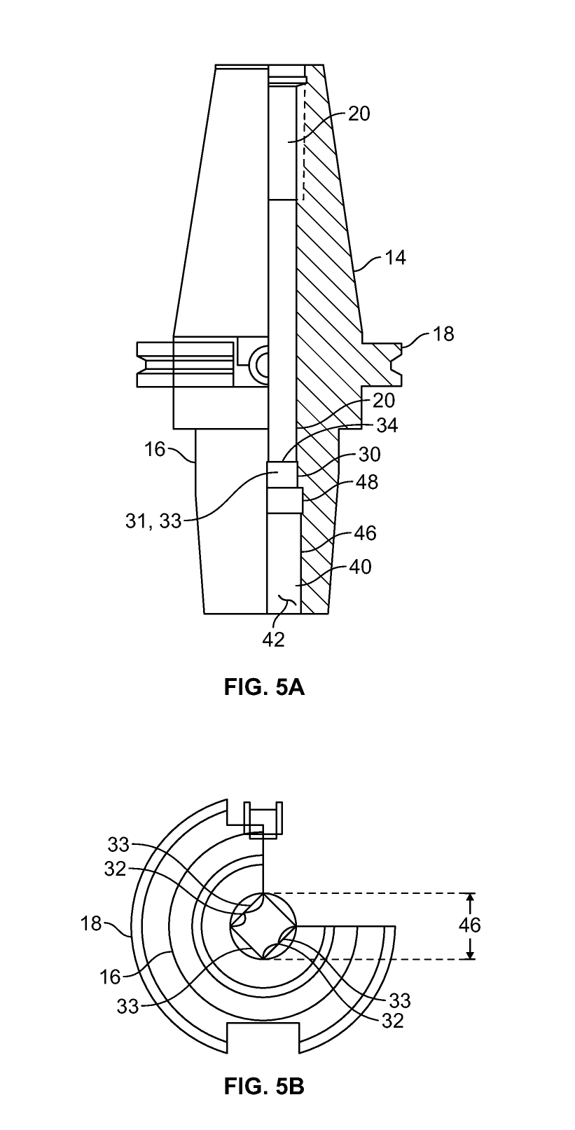

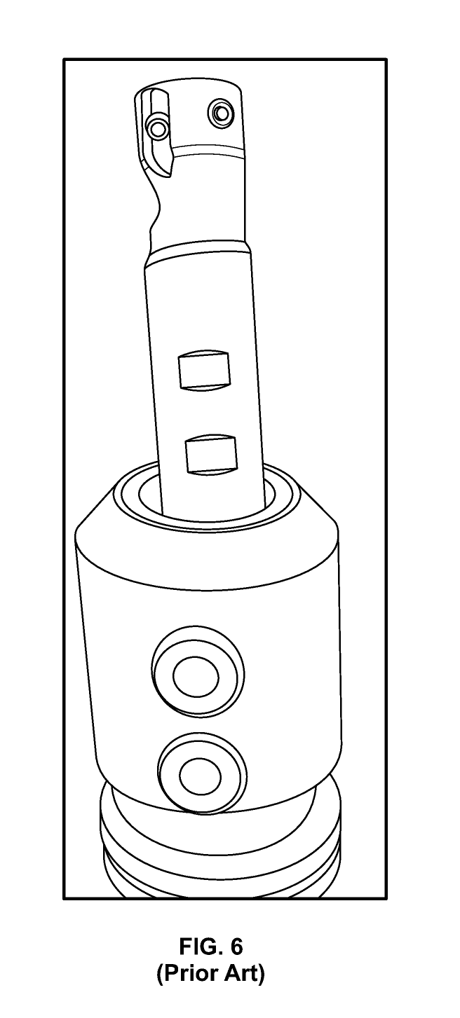

Referring to FIG. 4, an alternative second illustrative embodiment of the machine tool holder 100 includes a locking adaptor 21. The locking adaptor 21 is mounted securely in the through hole 20 of the tool holder 100. A shoulder 24 is defined between a first end 26 and a second end 28 of the locking adaptor 21. The shoulder 24 of the adaptor 21 abuts the abutting surface 19 defined by the through hole 20.

The locking adaptor 21 may be similar to a set screw used to limit axial depth of a cutting tool shank 52 in the tool holder body 11; however, in this case the recess as described for the first illustrative embodiment is defined in the second end 28 of the adaptor 21 and receives the keyed end 56 of the cutting tool shank 52.

An external thread 23 is formed around the first end 26 of the adaptor 21 and is screwed into a matching threaded portion 25 of the through hole 20. The external thread 23 must be oriented so that locking adaptor 21 will tighten and not loosen during cutting. Because machine tool spindles typically rotate clockwise, the external thread 23 and associated matching threaded portion 25 are typically right-hand threads (which is opposite of that typically used for set screws).

Locking adaptor 21 can also include a coolant hole 27 axially formed through the locking adaptor 21 and communicating with the recess 30, thus allowing for liquid coolant flow from the machine spindle (not shown) to the cutting tool 50.

While the invention has been illustrated and described in detail in the foregoing drawings and description, the same is to be considered as illustrative and not restrictive in character, it being understood that only illustrative embodiments thereof have been shown and described and that all changes and modifications that come within the spirit and scope of the invention as defined in the claims and summary are desired to be protected.

1. A machine tool holder for a cutting tool, comprising:
a connecting section on a machine tool end;
a cylindrical receiving bore on a cutting tool end; and
a keyed recess defined within the tool holder, the keyed recess in communication with the receiving bore, the keyed recess having an inner surface axially aligned with the receiving bore, the inner surface defining a non-circular cross section along its length.

2. The machine tool holder of claim 1, further comprising a locking adaptor having a first end, a second end opposite to the first end of the locking adaptor, and wherein:
the locking adaptor is rotationally fixed with the tool holder at the base of the receiving bore; and
the keyed recess is defined by the second end of the locking adaptor.

3. The machine tool holder of claim 2, wherein the locking adaptor has a coolant hole axially formed through the locking adaptor and communicating with the recess.

4. The machine tool holder of claim 2, further comprising a threaded receptacle defined axially by the tool holder at the base of the receiving bore; and wherein:
the locking adaptor further includes an external threaded part formed around the first end of the locking adaptor; and
the external threaded part is screwed in the threaded receptacle.

5. The machine tool holder of claim 1, wherein the keyed recess is positioned at a base of the cylindrical receiving bore opposite the cutting tool end.

6. The machine tool holder of claim 1, wherein the cylindrical receiving bore is toleranced to provide a transitional fit with a shank of the cutting tool, the transitional fit requiring thermal expansion of the cylindrical receiving bore to receive the shank and providing hand extraction of the shank from the tool holder upon subsequent thermal expansion.

7. The machine tool holder of claim 1, wherein the inner surface defines a plurality of corners.

8. The machine tool holder of claim 1, wherein the inner surface defines a plurality of flats.

9. The machine tool holder of claim 1, wherein the cross sectional shape of the inner surface is rectangular.

10. The machine tool holder of claim 1, wherein the cross sectional shape of the inner surface is triangular.

11. The machine tool assembly as claimed in claim 1, wherein the recess defines a coolant hole axially formed therein and in communication with the connecting section.

12. A machine tool holder assembly, comprising:
a machine tool holder having:
a connecting section on a machine tool end;
a receiving bore on a cutting tool end; and
a keyed recess defined within the tool holder, the keyed recess in communication with the receiving bore, the keyed recess having an inner surface axially aligned with the receiving bore, the inner surface defining a non-circular cross section; and
a cutting tool having a shank and a keyed end defined by the end of the shank; and
wherein:
the keyed end is engaged in the recess, thereby preventing rotation of the cutting tool relative to the machine tool holder; and
an inside diameter of the receiving bore is about equal to an outside diameter of the shank such that the two can be joined or separated using thermal expansion of the receiving bore, thereby substantially reducing eccentricity of the cutting tool relative to the machine tool holder.

13. The machine tool holder assembly of claim 12, wherein a process of coupling the holder and cutting tool, comprises:
heating the body of tool holder until the inside diameter of the receiving bore expands to a diameter greater than the outer diameter of the tool shank; and
positioning the tool shank within the receiving bore such that the keyed end of the tool shank is engaged in the recess.

14. The machine tool holder assembly of claim 12, further comprising a locking adaptor having a first end, a second end opposite to the first end of the locking adaptor, and wherein:
the locking adaptor is rotationally fixed with the tool holder between the connecting section and receiving bore; and
the recess is defined by the second end of the locking adaptor.

15. The machine tool holder assembly of claim 12, wherein the keyed recess is positioned at a base of the cylindrical receiving bore opposite the cutting tool end.

16. The machine tool holder assembly of claim 12, wherein the cylindrical receiving bore is toleranced to provide a transitional fit with the shank of the cutting tool, the transitional fit requiring thermal expansion of the cylindrical receiving bore to receive the shank and providing hand extraction of the shank from the tool holder upon subsequent thermal expansion.

17. The machine tool holder assembly of claim 12, wherein the inner surface defines a plurality of corners and the keyed end includes a matching set of plurality of corners.

18. The machine tool holder assembly of claim 12, wherein the inner surface defines a plurality of flats and the keyed end includes a matching set of plurality of flats.

19. The machine tool holder assembly of claim 12, wherein in the cross sections of the inner surface and the keyed end are rectangular.

20. The machine tool assembly as claimed in claim 12, wherein the keyed recess defines a coolant hole axially formed therein and in communication with the connecting section.
